(19) United States
(12) Patent Application Publication
(10) Pub. No.: US 2026/0318221 A1
(43) Pub. Date: Oct. 15, 2026

(54) INSPECTION DEVICE AND METHOD FOR INSPECTING AT LEAST ONE INNER FACE OF A DRUM FOR A TURBINE ENGINE TURBINE OR COMPRESSOR

(71) Applicant: SAFRAN AIRCRAFT ENGINES, Paris (FR)

(72) Inventors: Bastien-Marie DOUCET, MOISSY-CRAMAYEL (FR); Philippe Jean-Marie ANTUNES, MOISSY-CRAMAYEL (FR); Franck AUDELAN, MOISSY-CRAMAYEL (FR)

(21) Appl. No.: 19/481,084

(22) PCT Filed: Apr. 23, 2024
(86) PCT No.: PCT/FR2024/050527

§ 371 Date: Nov. 3, 2025

(30) Foreign Application Priority Data
May 3, 2023 (FR) 2304437

(51) Int. Cl. F01D 21/00

(52) U.S. Cl. CPC F01D 21/003; F05D 2270/8041

(57) ABSTRACT

An inspection device for inspecting at least one inner face of an inter-disc cavity of a longitudinal-axis drum for a turbine engine compressor or turbine, includes an arm having a first segment extending between a first end of the first segment and a second end of the first segment along a first axis and a second segment extending between a first end of the second segment and a second end of the second segment along a second axis, the second segment being integral with the first segment, the second axis being inclined relative to the first axis. An inspection head having a base is pivotably mounted at the second end of the second segment so as to pivot about a third axis perpendicular to the second axis, and a high-resolution camera is secured to the base and has an optical axis that is perpendicular to the third axis.

### TECHNICAL FIELD

This description relates to an inspection device for inspecting at least one inner face of a longitudinal-axis drum for a turbine engine compressor or turbine. This description also relates to a first assembly comprising such an inspection device and an actuator, as well as relating to a system comprising such a first assembly. This description also relates to a second assembly comprising such an inspection device and a mechanism for locking a transmission system of the device. Finally, this description relates to a method for inspecting at least one inner face of a drum for a turbine engine compressor or turbine, by means of the first assembly or in a system comprising the first assembly.

### PRIOR ART

A drum of a compressor or turbine for a turbine engine having a longitudinal axis comprises several rotor discs arranged one after the other along the axis of the turbine engine. The discs are connected to each other by annular walls that may be substantially cylindrical or frustoconical. The drum therefore has a tubular shape. Each disc and each annular wall defines at least one inner face of the drum. The drum also comprises annular inter-disc cavities formed longitudinally between two longitudinally consecutive discs.

Such a drum is a critical part of the turbine engine, such that, after it is machined and during regular inspections, the inner faces of the drum are examined to ensure it is within specifications and does not contain any defects (cracks, dents, scratches, etc.) that could affect its integrity during operation of the turbine engine.

However, due to the drum's geometry, inspection of the inner faces is difficult. The inter-disc cavities are difficult to access. One known method for inspecting the inner surfaces of each inter-disc cavity is endoscopy. However, this method does not allow obtaining images at a sufficient resolution for a high-quality inspection. Furthermore, this method does not fully address the disadvantages associated with the lack of access to the inter-disc cavities, and therefore does not allow inspecting all the inner surfaces of the inter-disc cavities.

The present description aims in particular to provide a simple, economical, and effective solution to the problems mentioned above.

### SUMMARY

An inspection device is proposed which is adapted for inspecting at least one inner face of an inter-disc cavity of a longitudinal-axis drum for a turbine engine compressor or turbine, the inspection device comprising:
an arm comprising a first segment extending between a first end and a second end along a first axis, and a second segment extending between a first end and a second end along a second axis, the second segment being integral with the first segment, the second axis being inclined relative to the first axis;
an inspection head comprising:
   a base pivotably mounted at the second end of the second segment so as to pivot about a third axis that is perpendicular to the second axis;
   a high-resolution camera secured to the base and having an optical axis that is perpendicular to the third axis.

The device is adapted for insertion of the inspection head inside the drum, and in particular into an annular inter-disc cavity formed longitudinally between two longitudinally consecutive discs of the drum. Also, the pivoting of the inspection base allows inspecting each inner face of the drum. Particularly advantageously, due to the pivoting of the camera, each point of the inner faces of the drum can be inspected by ensuring that the optical axis does not form an angle greater than 45°with an axis passing through said point and oriented perpendicularly to the inner face at said point. In other words, it is ensured that each point of each inner face of the drum can be inspected by having the optical axis of the camera included in a cone having said point as its apex and having the axis passing through said point, and oriented perpendicularly to the inner face at said point, as its generatrix. Thus, the quality of the images obtained by the camera is better and the inspection is improved.

The second axis may be perpendicular to the first axis. The third axis may be perpendicular to the first axis and second axis.

A portion of the first end of the second segment may be integral with a portion of the second end of the first segment. All or part of the first segment and second segment may be made as one piece (i.e. a single unit). Alternatively, the first segment and the second segment may be attached and fixed to each other.

The inspection device may comprise a transmission system adapted to be coupled with an actuator in order to pivot the base of the inspection head about the third axis. The first segment and the second segment may define an internal volume, for example a parallelepiped, in which all or part of the transmission system is housed.

The inspection device is thus more compact, which facilitates its insertion into the drum, and in particular into an annular inter-disc cavity formed longitudinally between two longitudinally consecutive discs of the drum.

The transmission system may comprise at least:
a first pinion arranged inside the first segment at the first end, the first pinion being adapted to be rotated about a fourth axis by an actuator,
a first belt arranged inside the first segment and meshing with the first pinion so as to be rotated by the rotation of the first pinion about the fourth axis,
a second pinion arranged inside the second segment at the second end, the second pinion being integral in rotation about the third axis with the base of the inspection head;
a second belt arranged inside the first segment and inside the second segment, the second belt meshing with the second pinion so as to rotate the second pinion about the third axis;
a transmission mechanism for transmitting the rotational movement of the first belt to the second belt, the transmission mechanism being arranged inside the first segment at the second end.

The fourth axis may be perpendicular to the first axis and/or to the second axis.

The transmission mechanism may mesh with the first belt and the second belt. The transmission mechanism may comprise a third pinion mounted so as to pivot about a fifth axis relative to the first segment and meshing with the first belt. The transmission mechanism may comprise a fourth pinion mounted so as to pivot about the fifth axis relative to the first segment and meshing with the second belt. The third pinion and fourth pinion may be integral in rotation with each other about the fifth axis, for example by means of a shaft extending along the fifth axis and on which each of the third pinion and fourth pinion are fixedly mounted. Said shaft may be fixed to the first segment. The fifth axis may be parallel to the third axis.

The first belt and/or the second belt may each have teeth. The first belt may be rotated about the first pinion and the third pinion. The second belt may be rotated about the second pinion and the fourth pinion. It is not excluded that the transmission system may comprise at least one other pinion for guiding the rotation of the first belt and/or at least one other pinion for guiding the rotation of the second belt.

The inspection head may comprise lighting means adapted to emit light radiation in a direction that is coincident with the optical axis. The inspection means may allow improving the quality of the image recorded by the camera and therefore may provide a more precise inspection of the surface condition. The inspection head may comprise a first light secured to the base and adapted to emit ultraviolet radiation in a direction that is coincident with a direction of the optical axis of the camera and/or a second light secured to the base and adapted to emit white light in a direction that is coincident with a direction of the optical axis.

The first light may be adapted to emit light radiation having a wavelength between 250 nm and 400 nm, preferably between 350 nm and 375 nm, preferably equal to 365 nm. Such ultraviolet light radiation is particularly suitable for interacting with certain substances or products that reflect this radiation in the visible range.

The inspection head may comprise a lens arranged in front of the first light and adapted to filter light radiation having a wavelength between 250 nm and 400 nm. In other words, the lens may form a bandpass filter which allows the passage of light radiation having a wavelength between 250 nm and 400 nm. The lens may form a bandpass filter having a central wavelength between 300 nm and 400 nm, preferably between 325 nm and 350 nm. The lens may have a transmittance that is greater than or equal to 40%. Thus, the first light and the lens may be arranged at a distance of between 1 cm and 5 cm, preferably between 2 cm and 3 cm, from the illuminated surface while still avoiding white light contamination. Indeed, known ultraviolet light sources are generally designed to be arranged at a distance of between 20 cm and 30 cm, and their use at a reduced distance (for example between 1 cm and 5 cm) causes white light to appear on the illuminated surface which interferes with the inspection of the surface under ultraviolet light. Also, the first light and the lens may be adapted to obtain sufficient irradiance for the camera to capture images, in particular an irradiance that is greater than or equal to 1200 μW/cm², preferably between 4000 μW/cm² and 5000 μW/cm².

The first light and/or the second light may be an LED (Light Emitting Diodes) light. The camera may have a resolution of between 2 MP and 16 MP. The camera may comprise a liquid lens. The inspection head may comprise a daughterboard. The inspection device may comprise a motherboard fixed to the first segment of the arm and connected to the daughterboard. The motherboard may be located closer to the second end of the first segment than to the first end of the first segment, so as to reduce the length of the connections with the daughterboard.

The inspection head may comprise a brush secured to the base. The brush may be adapted to apply a product to the face to be inspected or to remove excess product from the face to be inspected. Control over the pivoting of the base allows the brush to be manipulated within an inter-disc cavity, which in particular may be inaccessible to a human operator.

According to another aspect, a first assembly is proposed comprising the inspection device as described above and a motor which comprises a frame removably connected to the first segment of the arm and an output shaft coupled to the transmission system for pivoting the inspection head about the third axis.

The inspection device may thus be interchanged with another inspection device having a geometry and/or dimensions that are adapted to the drum to be inspected, while keeping the same actuator.

The first segment and/or the second segment of the arm may have dimensions adapted to the drum to be inspected. The angle between the first axis and second axis may be adapted to the drum to be inspected. The first segment may have a dimension along the first axis of between 300 mm and 1500 mm, preferably between 400 mm and 1000 mm. In other words, the internal volume of the first segment may have a dimension along the first axis of between 300 mm and 1500 mm, preferably between 400 mm and 1000 mm. The second segment may have a dimension along the second axis of between 80 mm and 400 mm, preferably between 90 mm and 300 mm. In other words, the internal volume of the second segment may have a dimension along the second axis of between 80 mm and 400 mm, preferably between 90 mm and 300 mm. Similarly, the head may have dimensions adapted for insertion into an inter-disc cavity of the drum to be inspected.

The output shaft may extend along the fourth axis. The motor may be adapted to pivot the output shaft about the fourth axis. The output shaft may be arranged at least partially inside the first segment, at the first end. The first pinion may be mounted on the output shaft such that they are integral in rotation about the fourth axis, and is removable.

The angular correspondence between the output shaft of the motor and the first pinion during their coupling may be obtained by the angular position known from the angular indexing of the first pinion and a known reference angular position of the motor shaft.

According to another aspect, a second assembly is provided comprising the inspection device as described above and a locking mechanism for immobilizing the first pinion inside the first segment, the locking mechanism preferably being adapted for angularly indexing the first pinion about the fourth axis relative to the first segment.

Such a locking mechanism firstly makes it possible to hold the first pinion in position in the first segment, in particular when the latter is not coupled to an actuator. It also makes it possible to block rotation of the first pinion about the fourth axis relative to the first segment and therefore rotation of the first belt relative to the first segment, in particular when the transmission system is not connected to an actuator. In addition, rotation of the first pinion may be blocked while being angularly indexed, i.e. knowing its angular position about the fourth axis and therefore knowing the angular position of the base of the inspection head about the third axis. Thus, the angular indexing of the first pinion allows coupling the first pinion to an actuator in a known angular position, and therefore with a known angular position of the base of the inspection head about the third axis. This makes it possible to ensure correct calibration between the control of an actuator and the pivot setpoint for the base of the inspection head about the third axis.

The inspection device may comprise a retaining member arranged inside the first segment, integral with the first pinion. The retaining member may comprise a recess in which the first pinion is partially housed. The retaining member may be fixed to the first pinion, for example by screws. The retaining member may be a disc centered on the fourth axis.

The locking mechanism may comprise at least one pin received jointly in a hole formed in the retaining member and a hole formed in the arm. The pin may extend in the direction of the fourth axis. The retaining member is thus made integral with the first segment. Such a pin makes it possible to simplify and shorten the uncoupling between the actuator and the first pinion in order to change out the inspection device while keeping the same actuator.

The locking mechanism may comprise at least one screw attaching the retaining member to the first segment.

The locking mechanism may comprise a plate, bearing against an outer face of the first segment at the first end in the direction of the first axis. Said pin may be integral with the plate. Said pin may further be received in an opening formed in the plate. Said screw of the locking mechanism may attach together said plate, the first segment, and the retaining member.

The retaining member may bear against a first face of the first pinion in the direction of the fourth axis. The output shaft of the motor may comprise a shoulder against which bears, in the direction of the fourth axis, a second face of the first pinion, opposite the first face in the direction of the fourth axis. The first pinion may therefore be clamped between the shoulder of the output shaft and the retaining member, along the direction of the fourth axis. The retaining member may be fixed to the output shaft, in particular by screwing in the direction of the fourth axis, so as to clamp the first pinion between the shoulder of the output member and the disc.

According to another aspect, a system is proposed comprising the first assembly as described above and a poly-articulated robot which comprises joints defining at least six axes of rotation and which is adapted to move and/or orient an end member according to six degrees of freedom, a portion of the first end of the first segment of the arm of the inspection device being removably fixed to the end member of the poly-articulated robot.

The system may further comprise a rotating support adapted to receive a longitudinal-axis drum for a turbine engine compressor or turbine, and adapted to rotate said drum about the longitudinal axis.

According to another aspect, a method is provided for inspecting at least one inner face of a longitudinal-axis drum for a turbine engine compressor or turbine, by means of the first assembly as described above, the drum comprising a plurality of annular discs arranged one after the other from upstream to downstream along the longitudinal axis and connected to each other by annular walls such that the drum comprises an internal cavity, the internal cavity further comprising annular inter-disc cavities formed longitudinally between each pair composed of an upstream disc and a downstream disc which are longitudinally consecutive among the plurality of discs, each inter-disc cavity being delimited by a downstream face of the upstream disc, an upstream face of the downstream disc, and an inner face of the annular wall connecting the upstream disc and the downstream disc, the method comprising the following steps:
moving the inspection device relative to the drum in order to partially insert the arm into the internal cavity of the drum until the inspection head is inside one of the inter-disc cavities of the internal cavity of the drum;
positioning the arm so as to arrange the third axis, which the base of the inspection head pivots about, to be perpendicular to the longitudinal axis;
pivoting the base of the inspection head about the third axis and capturing, by means of the camera, during the pivoting of the base of the inspection head about the third axis, a plurality of successive images of at least one among the downstream face of the upstream disc, the upstream face of the downstream disc, and the inner face of the annular wall which delimit said inter-disc cavity into which the inspection head is inserted.

The inter-disc cavity into which the inspection head is inserted may have a minimum dimension in the longitudinal direction that is less than or equal to 30 mm. In other words, the minimum distance in the longitudinal direction which separates the annular discs longitudinally delimiting the inter-disc cavity on either side may be less than or equal to 30 mm. The minimum distance in the longitudinal direction which separates the annular discs longitudinally delimiting the inter-disc cavity on either side may be at a radially inner portion of the discs. Each inter-disc cavity of the drum may have a minimum dimension in the longitudinal direction that is less than or equal to 30 mm.

The moving and positioning of the arm may be carried out by means of a poly-articulated robot. To insert the inspection head into one of the inter-disc cavities, the inspection device may first be moved longitudinally to insert the inspection head, the second segment, and a portion of the first arm into a central portion of the internal cavity, and then be moved radially to insert the inspection head into the inter-disc cavity. The motor may be moved along with the inspection device.

The drum may have a reference marking element, visible to the camera, to allow calibrating the position of the arm, and in particular of the inspection head, relative to the drum.

Once positioned, the first axis along which the first segment of the arm extends may be aligned with the longitudinal axis of the drum. The first segment may be partially received in the internal cavity of the drum. The second segment of the arm may be received in the internal cavity, and at least partially in the inter-disc cavity being inspected. The motor may be arranged outside the drum.

The inclination of the first axis along which the first segment of the arm extends and of the second axis along which the second segment of the arm extends may be determined according to, or even be coincident with, the inclination of each disc relative to the longitudinal axis of the drum. Each disc may extend perpendicularly to the longitudinal axis. In this case, the first axis and second axis may be perpendicular to each other.

The pivoting of the base of the inspection head may be performed over an angle of between 0° and 360°, by means of the motor.

The plurality of images may be captured out at a frequency of between 1 fps and 60 fps.

The method may comprise, during the capture of the plurality of images, illuminating said at least one among the downstream face of the upstream disc, the upstream face of the downstream disc, and the inner face of the annular wall which delimit said inter-disc cavity, by means of the first light or the second light.

The capture of the plurality of images, when illuminated by means of the first light (ultraviolet radiation), may be carried out after applying an indicator product which allows revealing surface defects on the downstream face of the upstream disc, the upstream face of the downstream disc, and the inner face of the annular wall which delimit said inter-disc cavity being inspected. This may be, for example, a fluorescent penetrating product that is sprayable. This allows highlighting the openings of discontinuities (fissures, cracks, etc.) on the downstream face of the upstream disc, the upstream face of the downstream disc, and the inner face of the annular wall which delimit said inter-disc cavity, during the capture of the plurality of images. The illumination by means of the first light (with ultraviolet radiation) may be carried out through (or by means of) a lens with bandpass filter allowing the passage of light radiation having a wavelength of between 250 nm and 400 nm and having a transmittance that is greater than or equal to 40%. Said at least one among the downstream face of the upstream disc, the upstream face of the downstream disc, and the inner face of the annular wall which delimit said inter-disc cavity, may be illuminated by means of the first light with said first light being arranged being at a distance of between 1 cm and 5 cm, preferably between 2 cm and 3 cm.

The capture of the plurality of images with illumination by means of the second light (white light) allows inspecting for the possible presence of impacts or scratches on the downstream face of the upstream disc, the upstream face of the downstream disc, and the inner face of the annular wall which delimit the inter-disc cavity being inspected.

The method may comprise, after the capture of the plurality of images, a step comprising the rotation of the drum about the longitudinal axis by means of the rotating support and a repetition of the steps of pivoting the base of the inspection head about the third axis and of capturing, by means of the camera, a plurality of successive images of at least one among the downstream face of the upstream disc, the upstream face of the downstream disc, and the inner face of the annular wall which delimit said inter-disc cavity into which the inspection head is inserted, during the pivoting of the base of the inspection head about the third axis.

The extent of the angle covered by the camera about the longitudinal axis on the downstream face of the upstream disc, the upstream face of the downstream disc, and the inner face of the annular wall which delimit said inter-disc cavity into which the inspection head is inserted during the capture of the plurality of images, may comprise each point of the downstream face of the upstream disc, of the upstream face of the downstream disc, and of the inner face of the annular wall for which an angle between the optical axis of the camera and an axis passing through said point while being respectively perpendicular to the downstream face of the upstream disc, the upstream face of the downstream disc, and the inner face of the annular wall, is less than 45°.

An angle of rotation of the drum about the longitudinal axis by means of the rotating support may be determined as a function of, or even as equal to, the extent of the angle covered by the camera about the longitudinal axis on the downstream face of the upstream disc, the upstream face of the downstream disc, and the inner face of the annular wall which delimit said inter-disc cavity into which the inspection head is inserted.

The steps of the rotation of the drum about the longitudinal axis and the repetition of the steps of pivoting the base of the inspection head about the third axis and of capturing a plurality of successive images may be repeated until the drum has been rotated 360° about the longitudinal axis.

The steps of the method as described above may be repeated for each inter-disc cavity of the drum.

### BRIEF DESCRIPTION OF DRAWINGS

Other features, details and advantages will become apparent upon reading the detailed description below, and upon analyzing the attached drawings, in which:

FIG. 1 is a perspective view showing a system for inspecting at least one inner face of a drum of a compressor or turbine for a turbine engine;

FIG. 2 is a first perspective view showing an inspection device and a motor of the system of FIG. 1;

FIG. 3 is a larger-scale view of the boxed area of the inspection device of FIG. 1;

FIG. 4 is a second perspective view of the inspection device and the motor of FIG. 2;

FIG. 5 is a partial perspective view of the inspection device and the motor of FIG. 2 and shows a locking mechanism in more detail;

FIG. 6 is a partial section view of the inspection device and the motor of FIG. 2 which also shows the locking mechanism in more detail;

FIG. 7 is a functional diagram of a method for inspecting at least one inner face of a drum of a compressor or turbine for a turbine engine;

FIG. 8 shows a step of the method of FIG. 7.

### DESCRIPTION OF EMBODIMENTS

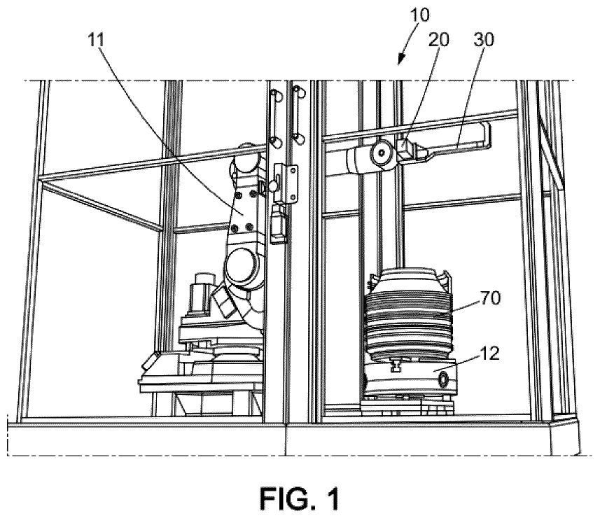

Reference is now made to FIG. 1, which shows a system 10 for inspecting at least one inner face of a longitudinal-axis X drum 70 of a compressor or turbine for a turbine engine.

In this disclosure, the longitudinal direction corresponds to the direction of the longitudinal axis X. The longitudinal axis X is coincident with the main direction in which the drum 70 extends and with the direction of the flow of gases from upstream to downstream in the drum 70 when said drum is in an operating turbine engine. Unless otherwise specified, orientation qualifiers such as “longitudinal”, “radial”, or “circumferential” are defined in reference to the longitudinal axis X. A radial direction is a direction perpendicular to the direction of the longitudinal axis X. A circumferential direction, at a point distant from the longitudinal axis X, corresponds to a direction perpendicular to the longitudinal and radial directions. Furthermore, unless otherwise specified, the adjectives “inner”, “internal”, “outer”, and “external” are used in reference to a radial direction such that the inner/internal (i.e. radially inner/internal) part of an element is closer to the longitudinal axis X than the outer/external (i.e. radially outer/external) part of the same element. Finally, the relative terms “upstream” and “downstream” are defined in relation to the normal direction of flow of fluid (from upstream to downstream) in the drum 70.

The drum 70 comprises a plurality of annular discs 71 arranged one after the other from upstream to downstream along the longitudinal axis X and connected to each other by annular walls 72. In other words, two longitudinally consecutive discs 71 are connected to each other by an annular wall 72. Each disc 71 may in particular comprise an annular hub, also sometimes called a balancing “bulb” due to its geometry. A radially outer periphery of the hub of each disc 71 may be adapted to receive an annular row of compressor or turbine blades. In the example illustrated and described below, each disc 71 extends perpendicularly to the longitudinal axis X. However, variant embodiments in which the discs 71 are inclined relative to the longitudinal axis X are not excluded. Each annular wall 72 connects radially outer end portions of the discs 71, in particular hubs of the discs 71. The annular walls 72 may be cylindrical or frustoconical about the longitudinal axis X. The drum 70 may have an axisymmetric shape about the longitudinal axis X. The drum 70 therefore comprises an internal cavity 73. In other words, the drum 70 has a tubular shape about the longitudinal axis X. The internal cavity 73 comprises annular inter-disc cavities 74 formed longitudinally between each pair composed of an upstream disc 71 and a downstream disc 71 which are longitudinally consecutive among the plurality of discs 71. Each inter-disc cavity 71 is delimited by a downstream face 71a of the upstream disc 71, an upstream face 71b of the downstream disc 71, and an inner face of the annular wall 72 connecting the upstream disc 71 and the downstream disc 71. The internal cavity 73 also comprises a central portion arranged radially inside the discs 71 and inter-disc cavities 74.

The system 10 shown in FIG. 1 comprises a poly-articulated robot 11, an inspection device, and an actuator. The poly-articulated robot 11 is what is referred to as a “six-axis” robot, as it comprises joints defining at least six axes of rotation and it is adapted to move and/or orient an end member according to six degrees of freedom.

The system 10 also comprises a rotating support 12 adapted to receive a longitudinal-axis X drum 70 for a turbine engine compressor or turbine, and to rotate it about the longitudinal axis X. Also visible in FIG. 1 is a turbine engine drum 70 as described above and arranged on the rotating support 12.

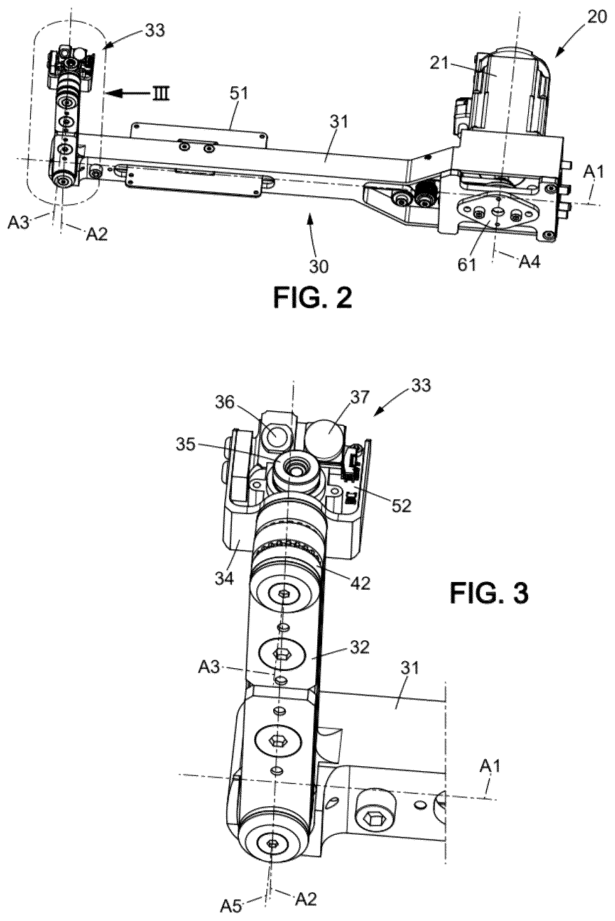

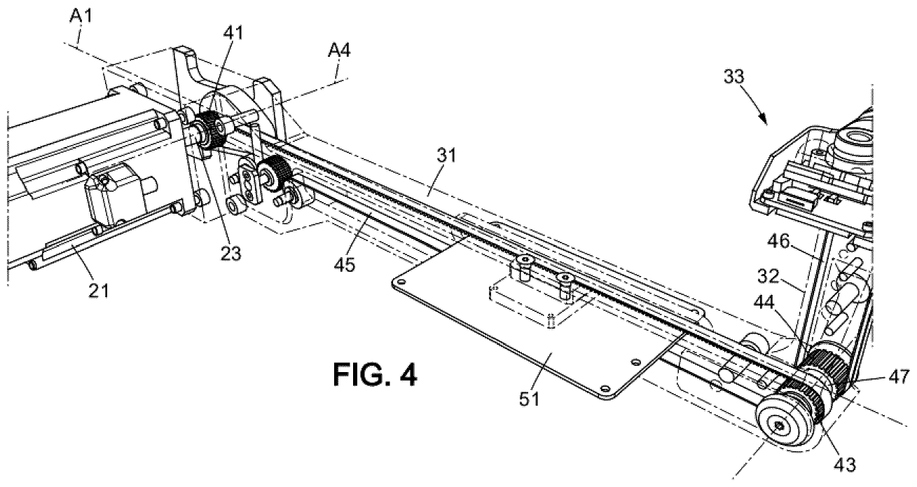

The inspection device can be seen in more detail in FIGS. 2 to 6. The device comprises an arm 30 comprising a first segment 31 and a second segment 32. The first segment 31 extends between a first end and a second end along a first axis A1, and the second segment 32 extends between a first end and a second end along a second axis A2. The second axis A2 is inclined relative to the first axis A1. The second axis A2 here is perpendicular to the first axis A1. The second segment 32 is integral with the first segment 31. In the current case, a portion of the first end of the second segment 32 here is integral with a portion of the second end of the first segment 31. As can be seen in FIG. 3, here the first segment 31 and the second segment 32 are made as one piece (i.e. a single unit). Alternatively, the first segment 31 and the second segment 32 may be attached and fixed to each other. A portion of the first end of the first segment 31 of the arm 30 of the inspection device is adapted to be fixed in a removable manner to the end member of the poly-articulated robot 11, for example by screwing. Lastly, the first segment 31 and the second segment 32 define an internal volume.

The inspection device further comprises an inspection head 33. The inspection head 33 firstly comprises a base 34 pivotably mounted at the second end of the second segment 32 so as to pivot about a third axis A3 perpendicular to the second axis A2. The third axis A3 here is perpendicular to the first axis A1 and to the second axis A2. The inspection head 33 also comprises a high-resolution camera 35 secured to the base 34 and having an optical axis AO perpendicular to the third axis A3. The camera 35 may have a resolution of between 2 MP and 16 MP. The camera 35 may comprise a liquid lens.

The device is therefore adapted for insertion of the inspection head 33 inside the drum 70, in particular into one of the inter-disc cavities 74. In a particularly advantageous manner, due to the pivoting of the camera 35, each point of the faces delimiting the inter-disc cavities 74 of the drum 70 can be inspected by ensuring that the optical axis AO does not form an angle greater than 45° with an axis passing through said point and oriented perpendicularly to the inner face at said point. In other words, it is ensured that each point of each inner face of the drum 70 can be inspected by having the optical axis of the camera 35 included in a cone having said point as its apex and having the axis passing through said point, and oriented perpendicularly to the inner face at said point, as its generator. The quality of the images obtained by the camera 35 is therefore better and the inspection is improved.

The inspection head 33 also comprises a first light 36 and a second light 37 which are secured to the base 34. The first light 36 is adapted to emit radiation within the ultraviolet, in a direction that is coincident with a direction of the optical axis AO of the camera 35. The second light 37 is adapted to emit white light in a direction that is coincident with a direction of the optical axis AO. The first light 36 and/or the second light 37 may be an LED (Light Emitting Diode) light 35. The inspection head 33 may comprise a daughterboard 52 allowing control of the camera 35, first light 36, and second light 37, and the processing of images captured by the camera.

The device further comprises a transmission system adapted to be coupled with the actuator in order to pivot the base 34 of the inspection head 33 about the third axis A3. The actuator here is a motor 20 which comprises a frame 21 removably connected to the first segment 31 of the arm 30 and an output shaft 22 coupled to the transmission system in order to pivot the inspection head 33 about the third axis A3. The inspection device may thus be interchanged with another inspection device having a geometry and/or dimensions adapted to the drum 70 to be inspected, while keeping the same actuator. The output shaft 22 extends along a fourth axis A4. The fourth axis A4 here is perpendicular to the first axis A1 and to the second axis A2. The motor 20 is capable of pivoting the output shaft 22 about the fourth axis A4. The output shaft 22 is arranged at least partly inside the first segment 31 at the first end. In the current case, a distal end portion of the output shaft 22 is arranged inside the first segment 31.

All or part of the transmission system is housed the transmission system. The inspection device is thus more compact, which facilitates its insertion into the drum 70, and in particular into an annular inter-disc cavity 74 formed longitudinally between two longitudinally consecutive discs 71 of the drum 70.

The transmission system comprises a first pinion 41 and a second pinion 42. The first pinion 41 is arranged inside the first segment 31 at the first end. The first pinion 41 is adapted to be rotated about a fourth axis A4 by an actuator. For this purpose, the first pinion 41 is removably mounted on the output shaft 22 and is integral in rotation therewith about the fourth axis A4. The second pinion 42 is arranged inside the second segment 32 at the second end. The second pinion 42 is integral in rotation about the third axis A3 with the base 34 of the inspection head 33.

The system comprises a first belt 45 and a second belt 46. The first belt 45 is arranged inside the first segment 31 and meshes with the first pinion 41 so as to be rotated by the rotation of the first pinion 41 about the fourth axis A4. The second belt 46 is arranged inside the first segment 31 and inside the second segment 32, the second belt 46 meshing with the second pinion 42 so as to rotate the second pinion 42 about the third axis A3.

The transmission system also comprises a transmission mechanism for transmitting the rotational movement of the first belt 45 to the second belt 46. The transmission mechanism is arranged inside the first segment 31 at the second end. The transmission mechanism meshes with the first belt 45 and with the second belt 46. The transmission mechanism comprises a third pinion 43 pivotably mounted so as to rotate about a fifth axis A5 relative to the first segment 31 and which meshes with the first belt 45, and a fourth pinion 44 pivotably mounted so as to rotate about the fifth axis A5 relative to the first segment 31 and which meshes with the second belt 46. The fifth axis A5 may be parallel to the third axis A3. The third pinion 43 and the fourth pinion are integral in rotation with each other about the fifth axis A5, by means of a shaft 47 extending along the fifth axis A5 and on which they are fixedly mounted. Said shaft 47 may be fixed to the first segment 31.

The first belt 45 is therefore rotated about the first pinion 41 and third pinion 43. The second belt 46 is rotated about the second pinion 42 and fourth pinion 44. The first belt 45 and/or the second belt 46 may each have teeth. It is not excluded that the transmission system may comprise at least one other pinion and/or roller for guiding the rotation or maintaining the tension of the first belt 45 and/or at least one other pinion and/or roller for guiding the rotation or maintaining the tension of the second belt 46.

The inspection device further comprises a retaining member 48 arranged inside the first segment 31, integral with the first pinion 41. The retaining member 48 comprises a recess in which the first pinion 41 is partially housed. The retaining member 48 here is fixed to the first pinion 41 by screws 49. The retaining member 48 here is again a disc 71 centered on the fourth axis A4. The retaining member 48 bears against a first face of the first pinion 41 in the direction of the fourth axis A4. The output shaft 22 of the motor 20 further comprises a shoulder against which a second face of the first pinion 41, opposite the first face in the direction of the fourth axis A4, bears in the direction of the fourth axis A4. The first pinion 41 is therefore clamped between the shoulder of the output shaft 22 and the retaining member 48, in the direction of the fourth axis A4. The retaining member 48 is fixed to the output shaft 22, here by a screw 23 extending in the direction of the fourth axis A4 so that the first pinion 41 is clamped between the shoulder of the output member and the disc.

In the event that the inspection device must be uncoupled from the motor 20, a locking mechanism is provided to immobilize the first pinion 41 inside the first segment 31. The locking mechanism is also adapted to angularly index the first pinion 41 about the fourth axis A4 relative to the first segment 31.

Such a locking mechanism firstly makes it possible to hold the first pinion 41 in position within the first segment 31, in particular when the latter is not coupled to an actuator. It also makes it possible to block rotation of the first pinion 41 about the fourth axis A4 relative to the first segment 31 and therefore rotation of the first belt 45 relative to the first segment 31, in particular when the transmission system is not connected to an actuator. In addition, rotation of the first pinion 41 may be blocked while being angularly indexed, i.e. knowing its angular position about the fourth axis A4 and therefore knowing the angular position of the base 34 of the inspection head 33 about the third axis A3. Thus, the angular indexing of the first pinion 41 allows coupling the first pinion 41 to an actuator in a known angular position, and therefore with a known angular position of the base 34 of the inspection head 33 about the third axis A3. This makes it possible to ensure correct calibration between the control of an actuator and the pivot setpoint for the base 34 of the inspection head 33 about the third axis A3.

The angular correspondence between the output shaft 22 of the motor 20 and the first pinion 41 during their coupling may be obtained by the angular position known from the angular indexing of the first pinion 41 and a known reference angular position of the motor shaft 20.

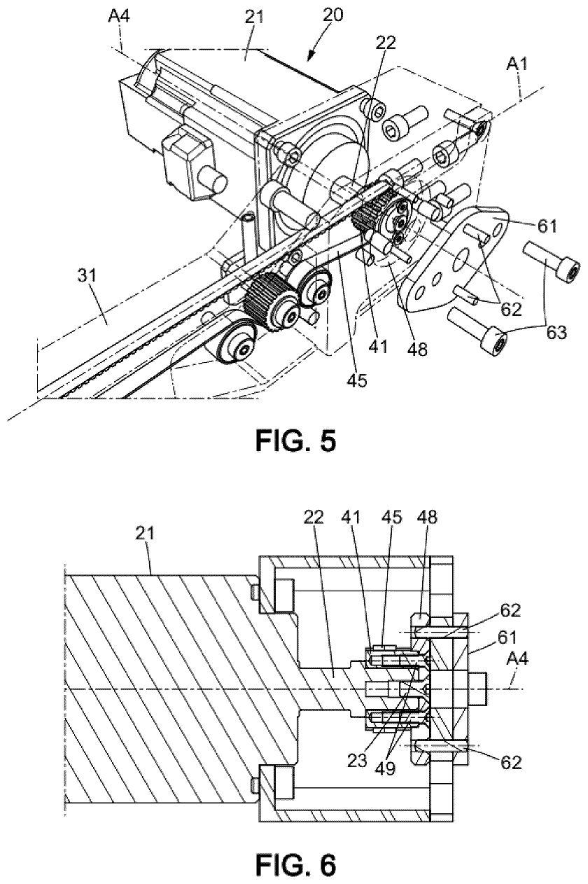

The locking mechanism here comprises two pins 62 each respectively received in both a hole formed in the retaining member 48 and a hole formed in the arm 30. Each pin 62 extends in the direction of the fourth axis A4. The retaining member 48 is thus made integral with the first segment 31. Such a pin 62 makes it possible to simplify and shorten the uncoupling between the actuator and the first pinion 41 in order to change out the inspection device while keeping the same actuator. When the inspection device is stored (i.e. when it is not in use), the locking mechanism may comprise at least two screws 63 fixing the retaining member 48 to the first segment 31. The locking mechanism here also comprises a plate 61, bearing against an outer face of the first segment 31 at the first end in the direction of the fourth axis A4. Each pin 62 is integral with the plate 61 (for visibility purposes, the pins 62 are shown in FIG. 5 on the opposite side of the plate 61 relative to the arm 30). As can be seen in FIG. 6, the pins 62 are further received in an opening formed in the plate 61. Similarly, each screw 63 of the locking mechanism fixes together the plate 61, the first segment 31, and the retaining member 48.

Finally, the inspection device comprises a motherboard 51 fixed to the first segment 31 of the arm 30 and connected to the daughterboard 52. The motherboard 51 is located closer to the second end of the first segment 31 than to the first end of the first segment 31, so as to reduce the length of the connections with the daughterboard 52.

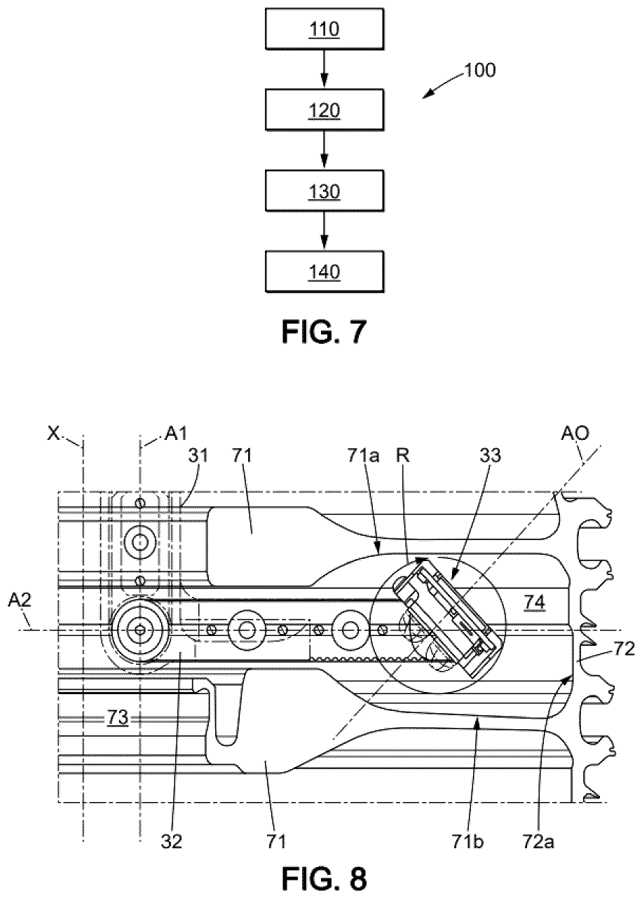

With reference to FIGS. 7 and 8, a method 100 is now described for inspecting at least one inner face of a longitudinal-axis X drum 70 as described above for a turbine engine compressor or turbine, in particular at least one face delimiting one of the inter-disc cavities 74 of the drum 70, and by means of the system 10 as described above.

The method 100 comprises a first step 110. The first step 110 comprises moving the inspection device relative to the drum 70 in order to partially insert the arm 30 into the internal cavity 73 of the drum 70 until the inspection head 33 is inside one of the inter-disc cavities 74 of the internal cavity 73 of the drum 70. The movement and positioning of the arm 30 are carried out by means of a poly-articulated robot 11. To insert the inspection head 33 into one of the inter-disc cavities 74, the inspection device is first moved longitudinally in order to insert the inspection head 33, the second segment 32, and a portion of the first arm 30 into the central portion of the internal cavity 73, then is moved radially to insert the inspection head 33 into the inter-disc cavity 74. The motor 20 is moved along with the inspection device. The drum 70 may have a radially internal reference marking element, visible to the camera 35, to allow calibrating the position of the arm 30, and in particular of the inspection head 33, relative to the drum 70.

The method 100 comprises a second step 120. The second step 120 comprises positioning the arm 30 in order to arrange the third axis A3, about which the base 34 of the inspection head 33 pivots, perpendicular to the longitudinal axis X. Once positioned, the first axis A1 along which the first segment 31 of the arm 30 extends is aligned with the longitudinal axis X of the drum 70. The first segment 31 is partially received in the internal cavity 73 of the drum 70. Furthermore, the second segment 32 of the arm 30 is arranged entirely within the internal cavity 73, and partially within the inter-disc cavity 71 being inspected. The motor 20 remains arranged outside the drum 70.

The method 100 comprises a third step 130. The third step 130 is shown in FIG. 8. The third step 130 comprises a first substep 110 which comprises pivoting the base 34 of the inspection head 33 about the third axis A3 (represented by the arrow R in FIG. 8). The pivoting of the base 34 of the inspection head 33 may be performed over an angle of between 0° and 360°, by means of the motor 20.

The third step 130 comprises a second substep 120 carried out simultaneously with the first substep 110 of the third step 130. The second substep 120 comprises the capture, by means of the camera 35, of a plurality of successive images of at least one among the downstream face 71a of the upstream disc 71, the upstream face 71b of the downstream disc 71, and the inner face 72a of the annular wall 72 which delimit said inter-disc cavity 74 into which the inspection head 33 is inserted, during the pivoting of the base 34 of the inspection head 33 about the third axis A3. The plurality of images may be captured at a frequency of between 1 fps and 60 fps.

The third step 130 comprises a third substep step 130 carried out simultaneously with the first substep 110 and second substep 120 of the third step 130. The third substep 130 comprises the illumination of said at least one among the downstream face 71a of the upstream disc 71, the upstream face 71b of the downstream disc 71, and the inner face 72a of the annular wall 72 which delimit said inter-disc cavity 74, by means of the first light 36 or second light 37.

The capture of the plurality of images with illumination by means of the first light 36 (ultraviolet radiation) may be carried out after having applied an indicator product which allows revealing surface defects on the downstream face 71a of the upstream disc 71, the upstream face 71b of the downstream disc 71, and the inner face 72a of the annular wall 72 which delimit said inter-disc cavity 74 being inspected. This may be, for example, a fluorescent penetrating product that is sprayable. This allows highlighting the openings of discontinuities (cracks, splits, etc.) on the downstream face 71a of the upstream disc 71, the upstream face 71b of the downstream disc 71, and the inner face 72a of the annular wall 72 which delimit said inter-disc cavity 74, during the capture of the plurality of images.

The capture of the plurality of images with illumination by means of the second light 37 (white light) allows inspecting for the possible presence of impacts or scratches on the downstream face 71a of the upstream disc 71, the upstream face 71b of the downstream disc 71, and the inner face 72a of the annular wall 72 which delimit said inter-disc cavity 74 being inspected.

The method 100 comprises a fourth step 140. The fourth step 140 is carried out simultaneously with or after the third step 130. The fourth step 140 comprises the rotation of the drum 70 about the longitudinal axis X by means of the rotating support 12.

The extent of the angle covered by the camera 35 about the longitudinal axis X on the downstream face 71a of the upstream disc 71, the upstream face 71b of the downstream disc 71, and the inner face 72a of the annular wall 72 which delimit said inter-disc cavity 74 into which the inspection head 33 is inserted when the capture of the plurality of images is requested, comprises each point of the downstream face 71a of the upstream disc 71, of the upstream face 71b of the downstream disc 71, and of the inner face 72a of the annular wall 72 for which an angle between the optical axis AO of the camera 35 and an axis passing through said point while being respectively perpendicular to the downstream face 71a of the upstream disc 71, the upstream face 71b of the downstream disc 71, and the inner face 72a of the annular wall 72, is less than 45°.

An angle of rotation of the drum 70 about the longitudinal axis X by means of the rotating support 12 may be determined as a function of, or even as equal to, the extent of the angle covered by the camera 35 about the longitudinal axis X on the downstream face 71a of the upstream disc 71, the upstream face 71b of the downstream disc 71, and the inner face 72a of the annular wall 72 which delimit said inter-disc cavity 74 into which the inspection head 33 is inserted.

The third step 130 and the fourth step 140 may be repeated until the drum 70 has been rotated 360° about the longitudinal axis X.

Finally, the steps of the method 100 as described above may be repeated for each inter-disc cavity 74 of the drum 70.

1. An inspection device adapted for inspecting at least one inner face (71a, 72a, 71b) of an inter-disc cavity (74) of a longitudinal-axis (X) drum (70) for a turbine engine compressor or turbine, the inspection device comprising:
an arm (30) comprising a first segment (31) extending between a first end of the first segment and a second end of the first segment along a first axis (A1), and a second segment (32) extending between a first end of the second segment and a second end of the second segment along a second axis (A2), the second segment (32) being integral with the first segment (31), the second axis (A2) being inclined relative to the first axis (A1);
an inspection head (33) comprising:
a base (34) pivotably mounted at the second end of the second segment (32) so as to pivot about a third axis (A3) that is perpendicular to the second axis (A2);
a high-resolution camera (35) secured to the base (34) and having an optical axis (AO) that is perpendicular to the third axis (A3).

2. The inspection device according to claim 1, comprising a transmission system adapted to be coupled with an actuator in order to pivot the base (34) of the inspection head (33) about the third axis (A3), and wherein the first segment (31) and the second segment (32) define an internal volume in which all or part of the transmission system is housed.

3. The inspection device according to claim 2, wherein the transmission system comprises at least:
a first pinion (41) arranged inside the first segment (31) at the first end of the first segment, the first pinion (41) being adapted to be rotated about a fourth axis (A4) by an actuator,
a first belt (45) arranged inside the first segment (31) and meshing with the first pinion (41) so as to be rotated by the rotation of the first pinion (41) about the fourth axis (A4),
a second pinion (42) arranged inside the second segment (32) at the second end of the second segment, the second pinion (42) being integral in rotation about the third axis (A3) with the base (34) of the inspection head (33);
a second belt (46) arranged inside the first segment (31) and inside the second segment

(32) the second belt (46) meshing with the second pinion (42) so as to rotate the second pinion (42) about the third axis (A3);
a transmission mechanism (43; 44; 47) for transmitting the rotational movement of the first belt (45) to the second belt (46), the transmission mechanism (43; 44; 47) being arranged inside the first segment (31) at the second end of the first segment.

4. The inspection device according to claim 1, the inspection head (33) comprising a first light (36) secured to the base and adapted to emit ultraviolet radiation in a direction that is coincident with a direction of the optical axis (AO) of the camera (35) and/or a second light (37) secured to the base and adapted to emit white light in a direction that is coincident with a direction of the optical axis (AO).

5. The inspection device according to claim 4, wherein the inspection head (33) comprises a lens arranged in front of the first light (36) and adapted to filter light radiation having a wavelength between 250 nm and 400 nm, the lens having a transmittance that is greater than or equal to 40%.

6. The inspection device according to claim 1, the inspection head (33) comprising a brush secured to the base and adapted to apply a product to the face to be inspected or to remove excess product from the face to be inspected.

7. A first assembly comprising:
the inspection device according to claim 2;
a motor which comprises a frame removably connected to the first segment of the arm; and
an output shaft coupled to the transmission system for pivoting the inspection head about the third axis.

8. A second assembly comprising:
the inspection device according to claim 3; and
a locking mechanism for immobilizing the first pinion (41) inside the first segment (31), the locking mechanism being adapted for angularly indexing the first pinion

(41) about the fourth axis (A4) relative to the first segment (31).

9. The second assembly according to claim 8, wherein the inspection device comprises a retaining member (48) arranged inside the first segment (31), integral with the first pinion (41), and the locking mechanism comprises at least one pin (62) received jointly in a first hole formed in the retaining member (48) and a second hole formed in the arm (30).

10. A system (10) comprising:
the first assembly according to claim 7; and
a poly-articulated robot (11) which comprises joints defining at least six axes of rotation and which is adapted to move and/or orient an end member according to six degrees of freedom, a portion of the first end of the first segment (31) of the arm (30) of the inspection device being removably fixed to the end member of the poly-articulated robot (11).

11. The system according to claim 10, further comprising a rotating support (12) adapted to receive a longitudinal-axis (X) drum (70) for a turbine engine compressor or turbine, and adapted to rotate said drum about the longitudinal axis (X) of the drum.

12. A method (100) for inspecting at least one inner face (71a, 72a, 71b) of an inter-disc cavity (74) of a longitudinal-axis (X) drum (70) for a turbine engine compressor or turbine, by means of the first assembly according to claim 7, the drum comprising a plurality of annular discs (71) arranged one after the other from upstream to downstream along the longitudinal axis (X) of the drum and connected to each other by annular walls (72) such that the drum comprises an internal cavity (73), the internal cavity (73) further comprising annular inter-disc cavities (74) formed longitudinally between each pair composed of an upstream disc (71) and a downstream disc (71) which are longitudinally consecutive among the plurality of discs, each inter-disc cavity (74) being delimited by a downstream face (71a) of the upstream disc (71), an upstream face (71b) of the downstream disc (71), and an inner face (72a) of the annular wall (72) connecting the upstream disc (71) and the downstream disc (71), the method comprising the following steps:
moving the inspection device relative to the drum (70) in order to partially insert the arm

(30) into the internal cavity (73) of the drum (70) until the inspection head (33) is inside one of the inter-disc cavities (74) of the internal cavity (73) of the drum (70);
positioning the arm (30) so as to arrange the third axis (A3), which the base (34) of the inspection head (33) pivots about, to be perpendicular to the longitudinal axis (X);
pivoting the base (34) of the inspection head (33) about the third axis (A3) and capturing, by means of the camera (35), a plurality of successive images of at least one among the downstream face (71a) of the upstream disc (71), the upstream face (71b) of the downstream disc (71), and the inner face (72a) of the annular wall (72) which delimit said inter-disc cavity (74) into which the inspection head (33) is inserted, during the pivoting (R) of the base (34) of the inspection head (33) about the third axis (A3).

13. The method according to claim 12, by means of the assembly according to claim 7 implemented in a system according to claim 10, the method (100) comprising, after the capture of the plurality of images, a step comprising the rotation of the drum (70) about the longitudinal axis (X) by means of a rotating support (12) and a repetition of the steps of pivoting the base (34) of the inspection head (33) about the third axis (A3) and of capturing, by means of the camera (35), a plurality of successive images of at least one among the downstream face (71a) of the upstream disc (71), the upstream face (71b) of the downstream disc (71), and the inner face (72a) of the annular wall (72) which delimit said inter-disc cavity (74) into which the inspection head (33) is inserted, during the pivoting (R) of the base (34) of the inspection head (33) about the third axis (A3).

14. The method according to claim 13, wherein an angle of rotation of the drum (70) about the longitudinal axis (X) by means of the rotating support (12) is equal to the extent of the angle covered by the camera (35) about the longitudinal axis (X) on the downstream face (71a) of the upstream disc (71), the upstream face (71b) of the downstream disc (71), and the inner face (72a) of the annular wall (72) which delimit said inter-disc cavity (74) into which the inspection head

(33) is inserted.

15. The method according to claim 12, wherein the extent of the angle covered by the camera (35) about the longitudinal axis (X) on the downstream face (71a) of the upstream disc (71), the upstream face (71b) of the downstream disc (71), and the inner face (72a) of the annular wall (72) which delimit said inter-disc cavity (74) into which the inspection head (33) is inserted during the capture of the plurality of images, may comprise each point of the downstream face (71a) of the upstream disc (71), of the upstream face (71b) of the downstream disc (71) and of the inner face (72a) of the annular wall (72) for which an angle between the optical axis (AO) of the camera (35) and an axis passing through said point while being respectively perpendicular to the downstream face (71a) of the upstream disc (71), the upstream face (71b) of the downstream disc (71), and the inner face (72a) of the annular wall (72), is less than 45°.
